(19) United States
(12) Patent Application Publication
(10) Pub. No.: US 2012/0022820 A1
(43) Pub. Date: Jan. 26, 2012

(54) METHOD FOR INERTIAL NAVIGATION UNDER WATER

(76) Inventors: Guenter Schmitz, Aachen (DE); Tim Schmitz, Aachen (DE)

(21) Appl. No.: 12/934,721

(22) PCT Filed: Apr. 17, 2009
(86) PCT No.: PCT/EP2009/002843

§ 371 Date: Oct. 17, 2010

(30) Foreign Application Priority Data
Apr. 17, 2008 (DE) 10 2008 019 444.1

(51) Int. Cl. G06F 15/00

(52) U.S. Cl. 702/95

(57) ABSTRACT

The invention relates to a method for underwater navigation, particularly for scuba divers, and for autonomous, manned, or remote-controlled underwater vessels, wherein the signals of at least one sensor, comprising at least one acceleration sensor for determining the actual position, are integratively analyzed, accuracy is improved by means of the use of reference measurements, and a correction is carried out by way of a correction vector obtained from the transformation of the vector of the accelerations measured by the acceleration sensor in the diving computer coordinate system into the global coordinate system, the comparison to at least one of the reference measurement values, the determination of the deviation and the reverse transformation of the deviation to the diving computer coordinate system.

### DESCRIPTION OF THE INVENTION

The invention relates to a method of inertial navigation under water, in particular for scuba divers.

### BACKGROUND OF THE INVENTION

Because of the limited range of visibility under water, which is at a maximum of 30-40 m most of the time and often significantly lower (2-10 m), orientation under water is often very difficult. During a customary diving time of between 30 and 60 minutes, the diver moves up to 500 m away from his entry point (for example a boat). In spite of bad visibility, he must be able to find the boat again in order to not end up in a life-threatening situation. Up to now, divers have had to depend on the use of simple compasses, that only indicate the direction of north, without registering the distance traveled.

Because of this difficulty, systems for determining boat position by ultrasound have been developed (so-called boat finders). Two-part systems of this type consisting of transmitter and receiver are cumbersome to handle, as the transmitter must be fastened to the boat at the start of the dive.

DE 3742423 describes a boat finder using ultrasound. U.S. Pat. No. 3,944,977, U.S. Pat. No. 3,986,161 and U.S. Pat. No. 5,570,323 also describe systems of this type. A further disadvantage of systems of this type is inherent therein, that a so to speak direct “sight connection” must exist with the boat, as the ultrasound signal cannot be go through rock spurs or other obstacles, or even indicates an incorrect direction.

A system would be much more useful that knows the position of the diver at least relative to the entry point and can thus display information about the direction and distance relative to the entry point. To do so, the path traveled by the diver would have to be recorded.

However, navigation systems based on GPS are not suitable because of the low depth of penetration of the satellite signals under the water surface (see also EP 1631830 [U.S. Pat. No. 6,972,715], U.S. Pat. No. 6,701,252, U.S. Pat. No. 6,791,490 and U.S. Pat. No. 6,807,127).

Inertial navigation systems are known from aviation and space flight, but they are out of the question for this application, because of their size and costs.

Innovative, micromechanical acceleration sensors are, however, in a position to measure precise straight-line and rotatory accelerations or angular velocity. By integrating these signals, the three-dimensional path that was traveled can be found and from it, the direction and distance from the initial position can be determined.

In EP 0870172 [U.S. Pat. No. 6,308,134], a vehicle navigation system is described using acceleration sensors in which a GPS signal is used for calibration.

As, however, no GPS system is available for calibration under water, the calibration must be performed by a different signal.

A small offset or sensitivity error can lead to an error of easily several hundred meters after only 10 minutes of diving time by using an inertial navigation system, because of the required double integration of the measured acceleration signals.

These types of sensor errors can be electronically compensated for by reference signals such as the measured ambient pressure (depth information) and if necessary, by a magnetic compass and perhaps additionally by the ability to receive GPS signals (for example, at or near the surface).

In US2007/0006472 A1, such a system is described. However, the method of correction remains unpublished. It is merely stated that additionally measured values are fed into the system in order to calculate back to the inertial error vector. How the inertial error vector is found is not disclosed.

### SUMMARY OF THE INVENTION

The present invention is a method of underwater navigation for scuba divers, as well as for autonomous, manned or remotely controlled underwater vehicles in which the signals of one or several, in particular straight-line acceleration sensors, as well as angle of rotation sensors and/or angular acceleration sensors and/or line-of-sight rate sensors for determining the actual position are integratively analyzed and hence precision is improved by utilizing reference measurements, by making a correction by a correction vector that is obtained from the transformation of the vector from an acceleration sensor, in particular a straight-line acceleration sensor—accelerations measured in the diving computer coordinate system in the global coordinate system, comparison with at least one of the reference measurement values, determination of the deviation and the reverse transformation of the deviation into the diving computer coordinate system.

The defective acceleration vectors of at least one of the acceleration sensors (for example, a straight-line acceleration sensor or also an angular acceleration sensor) can, for example, be corrected thereby, that a correction vector is found that is applied to the defective acceleration vector, whereby the correction vector can be found as follows:

A transformation of the defective acceleration vector takes place in the global coordinate system, a double integration of at least one selected defective coordinate of the transformed acceleration vector, the formation of the error magnitude of this selected coordinate at least by a specifically measured error-free reference value, in particular by subtracting at least the reference value from this selected coordinate, a determination of the error magnitudes of the remaining coordinates by the corrected coordinates determined in a previous step (in particular by calculating the difference) a double differentiation of the error magnitude of the selected coordinate and reverse transformation of the error magnitudes of all coordinates into the diving computer coordinate system, whereby the correction vector is formed from the reverse-transformed error magnitudes of the diving computer coordinate systems.

### DESCRIPTION OF THE DRAWINGS

FIG. 1 shows a system for determining and recording the position information with the help of an inertial navigation system INS;

FIG. 2 shows the principle of the implementation of the correction method in accordance with the invention;

FIG. 3 shows the more precise progression of the correction;

FIG. 4 shows an example of a possibility for finding a confidence factor;

FIG. 5 shows an example for a weighting function for suppressing correction values that are not sufficiently reliable;

FIG. 7 shows an alternative embodiment to that shown in FIG. 3.

FIG. 8 shows an additional alternative.

### DETAILED DESCRIPTION OF THE EMBODIMENT

The following will present a more precise description of the method in accordance with the invention. First, however, the terms “diving computer coordinate system” and “global coordinate system” will be addressed briefly.

The diver takes along the diving computer most often either on the arm or in a console. In the process, alignment of the computer with respect to the environment (global position) continually changes. Thus, for the determination of the movement in the “environment coordinate system” or “global coordinate system,” i.e. the motion or the acceleration forces that act upon the diving computer must be converted from the diving computer coordinate system into the global coordinate system.

The diving computer coordinate system can, in principle, be determined arbitrarily, for example, dependent on the insertion position (or insertion orientation) of the measuring chip used as sensor. For the sake of simplicity it can, for example, be assumed that the coordinate system of the diving computer is oriented in such a way that when the viewer looks at the display of a horizontally positioned diving computer precisely from above, the x axis points to the right, the y axis points “up” relative to the eyes of the viewer, and the z axis points precisely into the eye. These axes will be described in the following description as x_{T}, y_{T} and z_{T}.

In principle, the global coordinate system can also be selected completely arbitrarily. Here, it represents, relative to any map projection where the x axis points east, the y axis north and the z axis points perpendicular up out of the earth's surface and z=0 represents the actual water surface, for example, sea level. The axes of the global coordinate system will be described in the following by x_{w}, y_{w}, and z_{w}.

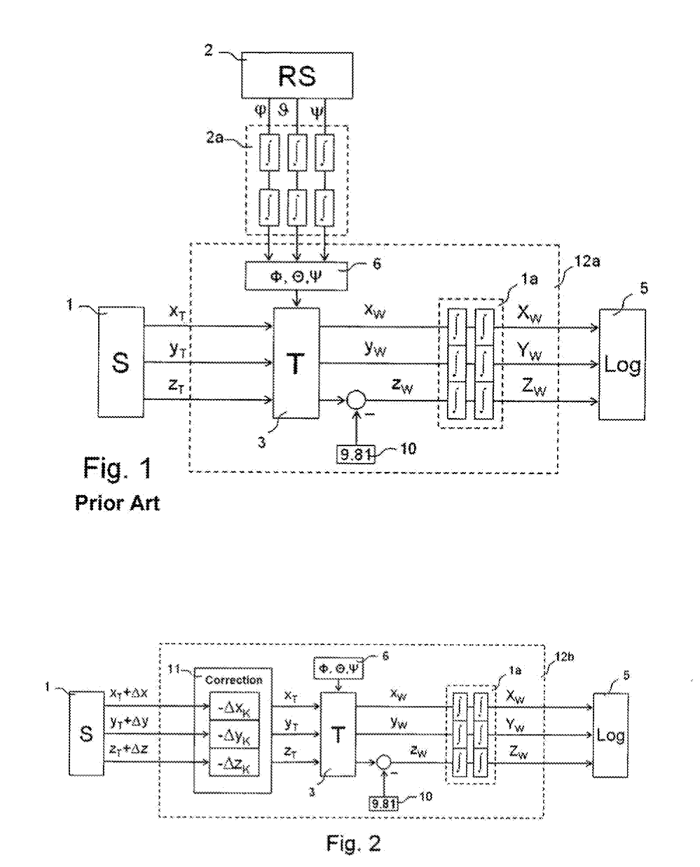

FIG. 1 shows a system for determining and recording the positioning information with the help of an inertial navigation system INS.

A triaxial acceleration sensor 1 (S), as well as a triaxial angular acceleration sensor 2 (RS=rotation sensor) make environment information available. These data are converted in the path calculation unit 12a into a path and are fed to the recording device 5. In detail, the analysis is performed using the following steps:

The raw data of the angular acceleration sensor 2 and the three angular accelerations j, z, and y are converted by double integration in integrator block 2a into solid angles and in the angle correction block 6, converted into the final solid angles φ, Θ, Ψ. How this correction is performed will be described later.

The raw data of the triaxial acceleration sensor 1 are naturally present as acceleration values in the coordinate system of the diving computer. These acceleration data are labeled x_{T}, y_{T} and z_{T}, where T identifies the diving computer coordinate system. The lower case letters indicate that these are accelerations. Upper case letters are used here to distinguish position information.

With the help of a transformation matrix 3 (T), the acceleration values from the diving computer coordinate system are transformed into the global coordinate system. The acceleration values of the global coordinate system x_{w}, y_{w} and z_{w} are thus obtained. The Z axis of the global coordinate system points in the direction of the geocenter, i.e. “down.” For this reason, for the analysis of the movement in the Z direction, first the gravitational acceleration 10 must be subtracted. It is approximately 9.81 m/s².

Subsequently, the acceleration in one path can be converted into a path with the help of a double integration in integrator block 1a (coordinates X_{w}, Y_{w}, Z_{w}). This is conveyed to a recording device 5 (log) for the (three-dimensional) path. There, the path information is then available for recording and additional utilization to provide information about the return path, etc.

In total, the matrix 3 (T) performs the following operation:

$$( \begin{matrix}{x}_{w} \\ {y}_{w} \\ {z}_{w}\end{matrix} ) = T \cdot ( \begin{matrix}{x}_{T} \\ {y}_{T} \\ {z}_{T}\end{matrix} )$$

The transformation matrix 3 (T) can consist of individual matrices for the individual rotations. Then, somewhat more clearly arranged relationships result, which are easier to understand.

Matrix T can be formed using the individual transformations around the respective axes:

T=Tₓ·T_{y}·Tₓ

where:

$${T}_{x} = ( \begin{matrix}1 & 0 & 0 \\ 0 & cos Φ & - sin Φ \\ 0 & sin Φ & cos Φ\end{matrix} ) , \\ {T}_{y} = ( \begin{matrix}cos Θ & 0 & sin Θ \\ 0 & 1 & 0 \\ - sin Θ & 0 & cos Θ\end{matrix} ) , \\ {T}_{z} = ( \begin{matrix}cos Ψ & - sin Ψ & 0 \\ sin Ψ & cos Ψ & 0 \\ 0 & 0 & 1\end{matrix} )$$

whereby φ represents the angle of rotation around the x axis, Θ the angle of rotation around the y axis, and Ψ the axis of rotation around the x [z] axis.

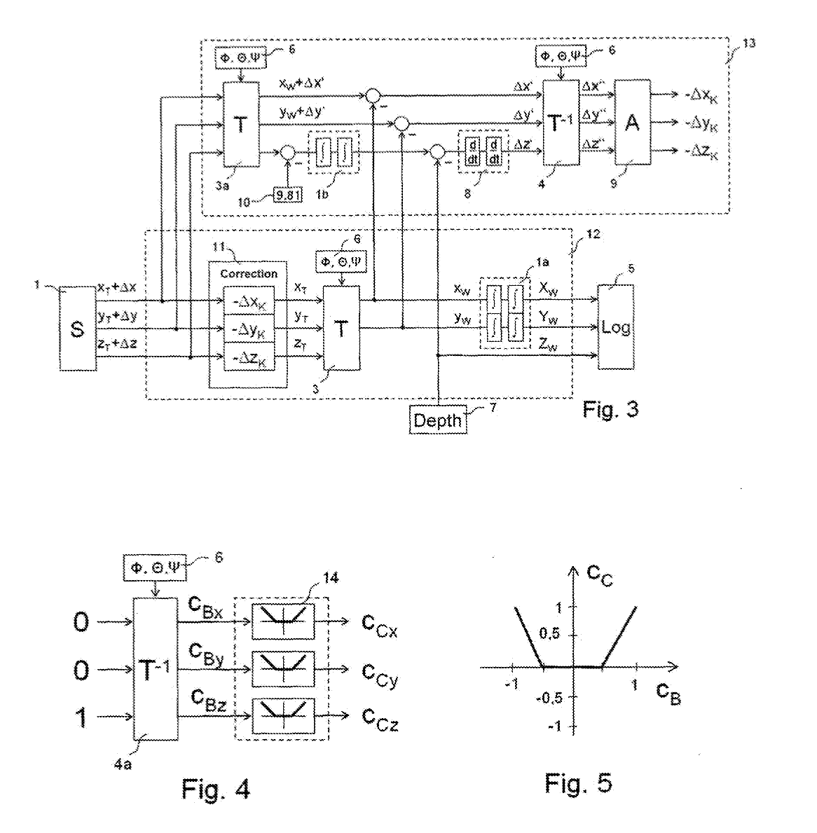

The method according to FIG. 1 is known. FIG. 2 shows the principle of the implementation of the correction method in accordance with the invention. This figure was inserted to improve the understanding of following FIG. 3 in which the progression of the correction is shown in greater detail. For reasons of simplification, the determination of the solid angles with respect to FIG. 1 was not shown. Only block 6 is shown for inputting the angles into the transformation matrix 3 (T). With respect to the path calculation unit 12a from FIG. 1, the path calculation unit 12b is expanded as follows: A correction block 11 is connected between the acceleration sensor 1 and the transformation matrix 3, the error of the acceleration values of the sensor unit 1 with respect to offset and linearity is corrected.

For the three axes, these errors are labeled Δx, Δy and Δz. The sensor unit 1 thus supplies the defective signals x_{T}×Δx, y_{T}+Δy and z_{T}+Δz. In the correction block 11, the errors of these signals are removed. Even if the illustration suggests here that only offset errors are removed and none of the linearity errors, these are also corrected, as in the analysis unit 9 (FIG. 3), both error types are determined and are being considered in the correction unit. However, for the sake of clarity, the illustration in FIG. 2 was kept as simple as possible.

FIG. 3 shows the determination of the correction values. The path calculation unit 12 of FIG. 3 corresponds closely to the path calculation unit 12b of FIG. 2. However, here, the Z coordinate is not determined from the acceleration sensor signals, but is taken directly from depth information 7, that comes from the pressure analysis of the diving computer for determining the diving depth.

This “pressure depth,” which is to be viewed as being correct is now also used in order to find the errors of the sensor signals in a correction value calculation block 13.

The function of the correction value calculation block 13 is as follows:

The defective sensor data x_{T}+Δx, y_{T}+Δy and z_{T}+Δz are first converted from the diving computer coordinate system into the global coordinate system using transformation matrix 3a. This transformation matrix is identical to transformation matrix 3. Now, the defective acceleration values x_{W}+Δx′, y_{W}+Δy′ and z_{W}+Δz′ are available in the global coordinate system as output of transformation matrix 3a. The identification of the error variables Δx′, Δy′, Δz′ with an apostrophe is to make it clear that these are not the original error values Δx, Δy and Δz.

Special attention only needs to be paid to the value of the Z direction, i.e. the “depth direction.” This value is first corrected, again by the value of the gravitational acceleration 10, by subtraction. Next, a calculation of the (defective) depth takes place in integrator 1b by double integration of the acceleration value. Now, a difference with respect to the depth 7 that was found by the pressure measurement is determined. The thus obtained error value for the depth is converted into an error value for the acceleration in the z direction Δz′, by differentiating two times in differentiator 8.

The two other channels for the x and the y acceleration are reduced with the help of the actually determined corrected values for x and y in the global coordinate system reduced to their absolute error magnitude. For this, the magnitude x_{w} is subtracted from x_{w}Δx′ and the magnitude y_{w} is subtracted from y_{w}+Δy′, and Δx′ and Δy′ remains. These are, together with the error value Δz′, fed to a transformation matrix 3a (T) that is inverse to transformation matrix 4 (T⁻¹). The error magnitudes Δx″, Δy″ and Δz″ now result as its output, which are now present in the coordinate system of the diving computer as a result of the reverse transformation. These values are fed to an analysis unit 9 for the determination of the correction factors.

This analysis unit 9 must now determine the correction values Δx_{K}, Δy_{K} and Δz_{K}.

This analysis is shown for the x component in FIGS. 4 to 6; it applies equally, however, to all other components. When determining the correction values it is important that the respective relevance of the magnitude of the correction is determined, because only the part coming from the depth information provides a real possibility for correction. Depending on the angle between the diving computer coordinate system and the global coordinate system, the depth information originates, however, in different sensors.

It is preferably provided that only one sensor, which is involved to a high degree in making depth information available, is corrected. For this reason, a “relevance” or “confidence” factor c, is introduced that is determined for each individual sensor from the actual solid angle.

A corresponding weighting vector for the depth information can, for example, be determined from the transformation of a vector that has only one component in the Z direction.

For example, FIG. 4 shows such a possibility for determining a confidence factor. A vector that is only assigned to ‘1’ in the Z direction is applied to the input of an inverse transformation matrix 4a, and thus transformed by the global coordinate system into that of the diving computer. At the output of the inverse transformation matrix 4a, there now result factors that indicate to which degree the respective sensor (of the diving coordinate system) had participated in the formation of the depth value (Z axis global) (participation value c_{B})

If one sensor did not participate at all, the value of c_{B} is ‘0’. If only one sensor was involved, this value is ‘1’, or also minus ‘1’ (at 180° rotation of the angle). In the case of intermediate angles, corresponding intermediate values result. In an optional further development it can be provided that behind the inverse transformation matrix 4a, still and additional “weight factor” 14 is connected or applied to the obtained values c_{B} that forms a non-linear connection between output and input. Thus, it can be provided, in the range of low participation values c_{B}, in is particular in the range of participation values below the respectively specified or predeterminable limit value that these confidence factors c_{C} are set to zero, in order to minimize the influence of other error values.

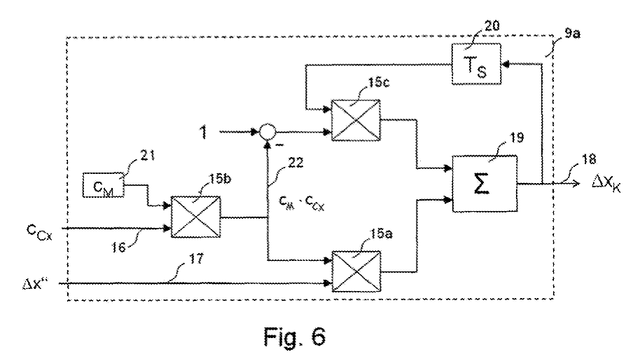

One example of a weighting function of this type is shown in FIG. 5. The corresponding calculation rule is:

If |c_{B}|≦0.5 then: c_{C}=0, thus, the value 0.5 is the cited limit value here

If |c_{B}|>0.5 then: c_{C}=2·(|c_{B}|−0.5)

It can thus be provided that for participation values c_{B} that are specified above a predetermined or predeterminable limit value, the respective confidence factor is specified by a calculation rule, in particular dependent on the participation value. This proposed weighting function is only an example that has provided good results in practice. Alternative functions such as, for example, a quadratic function are, however, equally possible and included in the scope of the patent claims.

Thus, even a very simple function that is below a certain value for c_{B} ‘0’ and above ‘1’ can be used. This then corresponds to a decision to let the correction become only effective then, when the direction of the corresponding acceleration sensor sufficiently agrees with the corresponding direction in which the direction of capture of the correction device (i.e. most often the depth, is in the z direction).

To determine the correction values Δx_{K}, Δy_{K}, and Δz_{K}, an algorithm for calculating the found confidence factors c_{CX}, c_{CY}, c_{CZ}, and the error magnitudes Δx″, Δy″ and Δz″, must still find application. Thereby, it is seen to be preferable, when the period of time during which an error is present is also included in the analysis.

In an advantageous embodiment, a digitally sliding average value formation is used, in which the algorithm follows the principle of calculating a new average value by including the new initial value only at a certain percentage P, and the old average value at the remaining percentage 100%−P.

If the current initial value is labeled a,” the old average value as a(k−1) and the new one as a(k), the following calculation rule results:

a(k)=a″·P+a(k−1)·(100%−P)

The chronological progression of such an average value formation depends on the one hand on the frequency of the execution (scanning rate) of this operation, and on the other hand, on the size of factor P. In the case of a high scanning rate and at a high percentage, a very fast adaptation of the average value to the new initial value results. In this connection, an accommodation can be made by introducing an “average value constant” c_{M}, that results from the scanning rate or the scanning interval T_{A} and the percentage P:

c_{M}=P·T

The confidence factor should—as described previously already—be included when building the average values of the correction values. This is achieved very easily by also including this factor when building the average value, in the same manner as the average value factor. The following is obtained:

a(k)=a″·c_{M}·c_{C}+a(k−1)·(1−c_{M}·c_{C})

When applying this algorithm directly to the error magnitudes Δx″, Δy″ and Δz″, the following correction values Δx_{K}, Δy_{K} and Δz_{K} result as follows:

Δx_{K}(k)=Δx″·c_{M}·c_{Cx}+Δx_{K}(k−1)·(1−c_{M}·c_{Cx})

Δy_{K}(k)=Δy″·c_{M}·c_{Cy}+Δy_{K}(k−1)·(1−c_{M}·c_{Cy})

Δz_{K}(k)=Δz″·c_{MM}·c_{Cz}+Δz_{K}(k−1)·(1−C_{M}·c_{Cz})

FIG. 6 [5] shows the application of the analysis method illustrated here on the x axis in a graph. In the analysis unit 9a for which the x axis (in the diving computer coordinate system), the error magnitude Δx″ (18) first gets to a multiplier 15a by being multiplied with the product of the average value constant c_{M} (21) and the confidence factor c_{Cx} (16) (formed in multiplier 15b). The second component for newly formed correction value Δx_{K} (18) in summarizing unit 19, results from the product formed in multiplier 15c by the delayed initial value 18—delayed by delay element 20—and the product of c_{M} and c_{C} that is subtracted from 1.

The correction factor in turn, can be broken down further in an iterative process into an offset part and a product part. Based on the fact that the offset acts primarily in the range of smaller acceleration values and the product part acts primarily in the range of large acceleration values, the defective value for x_{T}, here labeled as x_{T}′, can be expressed as follows:

x_{T}′=Δoₓ+(1+μmₓ)x_{T}

where Δoₓ represents the offset and Δmₓ the product part (ascending part).

The iterative calculation method of the offset and the product correction values can be performed with the following equations:

Δmₓ=(Δoₓ−Δx_{K})/x_{T}

Δoₓ=Δx_{K}−Δmₓ·x_{T}

Processing of other reference signals

In the event other reference signals than the depth information are available, these can be processed in a similar manner. The confidence factor is then separately calculated for each individual component that is to be corrected. For this, respectively the initial vector for the inverse transformation matrix in FIG. 4a is calculated with ‘1’, not in the z direction, but in the respectively relevant spatial direction assigned to ‘1’, and in the spatial directions that are not relevant assigned to ‘0’.

Limiting and alerting in the case of initial sensor values that are too high

Should the measured acceleration values (or in the case of angle sensors the correspondingly measured angular velocities) be above a predeterminable threshold value, an erroneous measurement must be assumed. In this case, the diver should be made aware in the display of the diving computer or in another suitable way, so that he knows that the determination of additional positions is perhaps erroneous. Further, the diver can also be asked (for example by an acoustic alarm signal), to remain at rest for a short period of time, so that the sensor can reset the integrators, and so that no erroneous velocity information can lead to errors in the further position calculation.

Angle Correction

In principle, the angle correction takes place in the same way as previously described for the straight-line accelerations. Thereby, a magnetic sensor (electronic compass) based on the earth's magnetic field can be used as reference signal. A further possibility consists of the utilization of the direction of the gravitational vector that always points in the direction of the axis of the earth with a deviation from the plumb line of only at a maximum 0.01°. For this, the average directional vector of the maximum acceleration can be used. This can in particular also take place when the diving computer is at rest, i.e. is not being moved, which can be derived from the unchanging signals for straight-line or rotatory accelerations. Perhaps a precise recalibration of the angle sensors can take place from time to time, by switching off the diving computer at first delayed, or even by switching it on automatically from time to time, or awakening it automatically from a resting position. Even today's diving computers continue to operate in resting position in order to perform monitoring of the ambient pressure or a calculation of the so-called desaturation times. Even the recalibration of the straight-line sensor can be performed in this mode.

Deviating from the application of the angle acceleration sensors shown in FIG. 1 and the following, special advantages can be achieved by using line-of-sight rate sensors, as the method then only respectively needs one single integration per angle direction, as a result of which the precision of the method is improved.

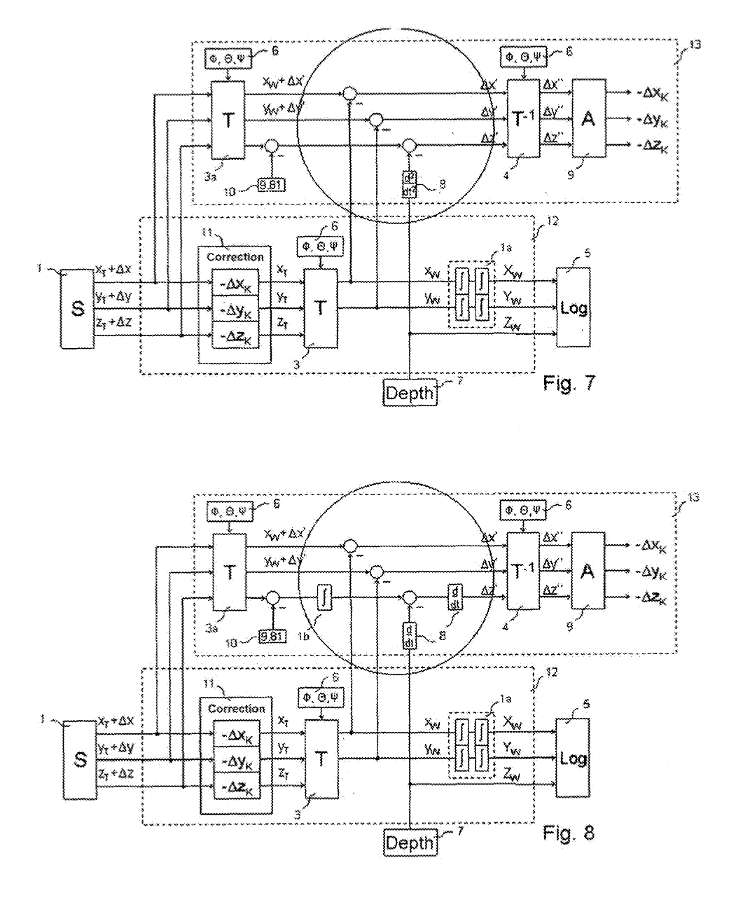

Even other embodiments than those shown above can be equivalent and depending on the type of the technical design (integration algorithms, etc. used) can be of advantage. As an example of this, reference is made to FIG. 3. There, even the integration and differentiation could take place at a different position; the complete integrator block 1b could be eliminated if simultaneously, the differentiator block 8 would be relocated to the negative input to the corresponding summation point (see FIG. 7). Only one of the integrators could be eliminated, and only one of the differentiators of block 8 could be displaced correspondingly (see FIG. 8).

Suspension of Calibration

Under certain circumstances, the calibration process is suspended for a certain sensor group. Thus, for example, outside of the water (recognizable at the water contact switch, as already mentioned previously, or also in the presence of depth information from the pressure signal of approximately zero), no suitable depth information is available from the pressure sensor. For this, the calibration of the straight-line acceleration sensors is suspended, for example, by setting all confidence factors to zero. The calibration of the angle sensors can, however, continue to be operated in it. These, in turn should be suspended when obviously implausible results are present from the analysis of the magnetic field sensors (i.e. for example, strong changes of the measured direction of the magnetic field at only small values of the angle velocity that are determined with the help of the angular velocity sensors.

### Other Preferred Embodiments

The path traveled under water can be recorded with the help of position information from acceleration sensors, angle sensors, in particular angular acceleration sensors, line-of-sight rate sensors, magnetic field sensors and/or pressure sensors for storing the position information depending on time and/or a meter reading.

The reference measurement for the coordinates X and Y in the global coordinate system as well as a sensor calibration can, as long as, for example, a GPS signal is available close to the surface, be performed by the GPS system. When receiving the GPS signals below the surface, in order to increase the precision, a correction of the delay time of the GPS data with respect to the propagation properties of the GPS signals under water can take place. Because of the relatively high dielectric constant of water of approximately 80, other propagation velocities of the GPS signals result under water. In particular, the depth information from GPS signals must hereby be corrected. In the simplest case, for this, the depth is corrected by a factor of the quotient between the propagation velocity of the electromagnetic waves in the expansion space and that under water.

Most of today's diving computers have a function whereby they automatically switch on as soon as they make contact with water. Preferably, this function can be used in order to, for example, set a reference point at the entry position in combination with a GPS signal that can still be received at the surface. A is further reference point can then be used directly when diving in (start of the dive).

In particular, the method in accordance with the invention is expediently useable in combination with a graphic display, on which the direction and the distance to the reference points is displayed. The position of the reference points as well as the previously dived path can be displayed on a map-like illustration. Corresponding depth information relative to the reference points or to the path can also be displayed. The path or the reference points can thereby also be shown in different colors depending on depth, so that the display remains easy to read, but still provides additional navigation information to the diver.

The diver can also set reference points himself during the dive, for example, by applying pressure to a button. The diver can also set reference points or destination points even prior to diving. Further, he can load path points POIs (points of interest) in advance from sources such as, for example, the Internet into the diving computer, and thus follow a predetermined path while diving in order to, for example, find shipwrecks or the hideouts of certain marine fauna.

Likewise, previously available map material can be loaded into the computer of the diver and can thus make the navigation and orientation easier. For this purpose, the north alignment of the system can be fixed at the beginning as per magnetic compass and if necessary, be corrected by long-term averaging. To determine the north alignment, the movements of the diver can also be determined by using (still) available GPS signals.

The dived path, as well as the reference points that were set can be read after concluding the dive or shown with, or without a map.

By radio transmission, even the position of the diver can perhaps be forwarded to another diver together with other data. This is particularly helpful when guiding larger groups. This type of information can also be sent to the diving boat or to the diving base. One advantage consists therein, that a dive leader, who bears responsibility, can review the location of a diver on land in order to perhaps direct the boat to that location, to initiate rescue operations or to also transmit new reference points or destination points (for example a new boat position) to the diver.

Radio transmission, does not only mean electromagnetic high frequency communication, rather, it covers any type of wireless communication such as, for example, ultrasound or light.

To further increase the precision of the depth measured by the ambient pressure, it can be corrected by the salt content of the water, and thus the density of the water. A corresponding measurement of the salt content can be performed by measuring the conductivity of the water, for example, by electrodes that are already present for the activation of the diving computer upon contact with water. In reverse, in the presence of depth information from other sources (calibrated acceleration sensors, GPS signal or similar, a determination of the salt content can take place by a comparison of this information with that of the ambient pressure sensor. Likewise, manual input, for example, the degree of latitude can take place.

A previously known temperature dependence of the sensors can be compensated by including the signals of a temperature sensor that is customarily available in a diving computer. Additional temperature sensors can also be used, that are respectively housed in the proximity of the sensors.

An increase in the precision of the calibration of the sensor can be achieved when the influence of the wave motion on the pressure measurement is reduced, for example, by forming the average value of the depth. For this, by using frequency analysis, the duration of a wave motion can be captured, and thus a favorable measure for the time constant, or the time period of the average value formation can be determined (simple or whole number multiples of the basic frequency). Even a measure for the waviness can be determined by analyzing the magnitude of the pressure fluctuations. This analysis can be done in various ways. In one embodiment—in a frequency range in which the usual wave frequencies occur in the beach area—the amplitude of the pressure fluctuations is determined and from this, converted to the fluctuations of the column of water above the diver. For this purpose, the same known formula is used as that for the conversion of the water pressure in the depth. As conversion factor, 10 m/bar is completely suitable. In the log book of the diving computer, a different recording of the waviness can then also occur. This recording can take place as a single value for a dive or also in a sequence of values that displays the progression of waviness.

A further increase in precision is achieved by the correction of the gravitational constant from the degree of latitude. The gravitational constant 10 (see FIG. 1) is not exactly the same everywhere, but depends on diverse conditions, in particular the degree of latitude. Gravity at the equator is 9.7803 m/s², at the North Pole 9.8322 m/s², and at the 45^{th} degree latitude: 9.80665 m/s². If information about the degree of latitude is already available (GPS measurement or manual input) this signal can be used directly. Thereby, a linear interpolation between the previously mentioned values can be performed. Other interpolation methods or methods with several support points can also be used.

If no information about the degree of latitude is available, an estimate of the degree of latitude can be made based on the water temperature, as the water temperature is naturally higher in tropical waters than in European degrees of latitude. Hereby, the salt content can be used additionally, in order to, in the case of inference of degrees of latitude based on temperature, and the usually present difference between sweet water and salt water, can also be included. Even the geographic elevation that can be determined from the ambient pressure prior to the dive is an influencing variable that can be included. The variables that can be considered in the determination of the degree of latitude are, however, not limited to these. Additional information such as the time of the year, stored climate zones, etc. can also be included.

Even measurements of magnetic fields can be used for the determination of the degree of latitude. In the case of a diving computer, the use of magnetic sensors in three dimensions is is suggested because of the very different orientations in the global coordinate system. From the z component of the magnetic field, inferences can be made with respect to the degree of latitude.

A further preferred embodiment consists of splitting up the measuring unit and the display unit. While the display unit is housed on the arm of the diver or in a console, or is integrated as head-up display in the mask of the diver, the measurement unit and/or the recording unit can be placed elsewhere. For example, an attachment at the buoyancy compensator of the diver is suggested, at the compressed air cylinder or elsewhere on the body of the diver. This has the advantage that the motions do not take place so quickly, the angle precision is improved thereby, and the acceleration values are also reduced in straight-line direction.

A further application results from equipping the underwater propulsion device (for example underwater scooter) with controls that are controlled depending on the position information obtained and the direction determined from such to a predeterminable destination (reference point) or a predeterminable path.

Deviating from the application shown in the drawing of the angular acceleration sensors, the line-of-sight rate sensors can be utilized, as then respectively only a single integration per angle direction is required, as a result of which the precision of the method can be improved.

### REFERENCE NUMBER LIST

1 S acceleration sensor (3 axes)
1a ∫ integrators for determining the path from the acceleration in the z direction
1b ∫ integrators for determining the depth from the acceleration
2 RS (rotation sensor) angular acceleration sensor (3 axis)
2a ∫ integrators for determining the angle from the angular acceleration
3 T transformation matrix
3a transformation matrix
4 T¹ inverse transformation matrix
4a T¹ inverse transformation matrix
5 log recording device for the three-dimensional path
6 Θ, Φ, Ψ determination unit for solid angles Θ, Φ, Ψ
7 depth depth value, for example from pressure measurement
8 d/dt differentiators for determining the acceleration in z direction
9 A analysis unit for determining the correction factors
9a analysis unit for determining the x correction factor
10 9.81 value of the actual gravitational acceleration
11 correction correction unit for correcting the errors of the acceleration sensors
12 path calculation unit, correcting
12a path calculation unit, without correction
12b path calculation unit, with simple correction
13 correction value calculation block
14 weighting unit
15a X multiplier 1
15b X multiplier 2
15c X multiplier 3
c_{Cx} confidence factor x axis
Δx″ magnitude of error x axis
18 Δx_{K} correction value for x axis
Σ summing unit
Tₛ time delay (by sample interval)
c_{M} average value factor
c_{M} c_{cx} product of confidence factor x axis and average value factor

1. A method of underwater navigation of scuba divers or autonomous, manned or remotely controlled underwater vehicles wherein
the signals of at least one sensor, comprising at least one acceleration sensor for determining the actual position are integratively analyzed,
the precision is improved by utilizing reference measurements, and
a correction takes place by a correction vector that is obtained from the transformation of the vector of accelerations measured by the acceleration sensor in the diving computer coordinate system in the global coordinate system, comparison with at least one of the reference measurement values, determination of the deviation and the reverse transformation of the deviation into the diving computer coordinate system.

2. The method according to claim 1, wherein the signals of a combination resulting from the at least one, in particular straight-line acceleration sensor and at least one angle of rotation or line-of-site rate sensor or angular acceleration sensor are integrated.

3. The method according to claim 1 wherein the reference measurement takes place in the form of a pressure measurement of the ambient water pressure.

4. The method according to claim 1 wherein the reference measurement is performed in the form of utilizing signals of a satellite navigation system.

5. The method according to claim 4, wherein the signals of the satellite navigation system are utilized as reference when at or in the proximity of the water surface, in particular directly prior or after starting the dive.

6. The method according to claim 1 wherein the reference measurement is performed by utilizing signals from the measurement of the earth's magnetic field.

7. The method according to claim 1 wherein a navigation aid is displayed for the diver on a display.

8. The method according to claim 7, wherein the display provides information about the direction or distance to a reference point.

9. The method according to claim 8, wherein the reference point is the starting point of the dive.

10. The method according to claim 8, wherein the display has an illustration that is similar to a map.

11. The method according to claim 7, wherein the display additionally shows a map that was previously loaded into the device or previously recorded or loaded or recorded reference points.

12. The method of recording the path traveled under water according to claim 1 wherein position information is recorded from acceleration sensors or angular sensors or line-of-sight rate sensors or magnetic field sensors or pressure sensors for storing position information depending on the time or a meter reading.

13. The method according to claim 1, wherein reference positions are stored in the memory of the diving computer prior to or during the dive.

14. The method according to claim 1, wherein the position of a diver is forwarded to another diver, in particular by radio communication or other types of communication.

15. The method according to claim 1, wherein pressure depth is corrected by information about the salt content of the water.

16. The method according to claim 15, wherein pressure depth and depth from other calculations are compared and that the salt content is determined from such.

17. The method according to claim 1, wherein a calibration of the map direction takes place in a map in the diving computer, in particular a stored map by a a determination of the direction north by a magnetic compass, analysis of the movements of the diver when a GPS signal is available, or diving to at least one reference point and confirmation by the diver to the diving computer that this at least one point was reached.

18. The method according to claim 1, wherein the calibration of the absolute position is derived from an at least one momentarily received GPS signal.

19. The method according to claim 1, wherein a correction of the delay time of the GPS data with respect to the propagation properties of the GPS signals takes place under water.

20. The method according to claim 1, wherein a measured temperature is used for error correction.

21. The method according to claim 1, wherein an average value formation of the depth occurs in order to reduce the influence of the waves on the depth determination.

22. The method according to claim 1, wherein a correction of the measured values obtained by the angular sensors is performed by the direction of the gravitational force.

23. The method according to claim 1, wherein a recalibration of the system takes place in calm phases.

24. The method according to claim 1, wherein the system is divided into measuring unit and display unit and that the measuring unit is attached to a part of the diver or his equipment, in particular a part that is not moved very much.

25. The method according to claim 1, wherein gravity is corrected by the information captured about the degree of latitude.

26. The method according to claim 1, wherein the temperature or salt content of the water or the date or the elevation are included in the determination of the degree of latitude or the gravitational constant prior to the dive.

27. The method according to claim 1, wherein a determination of the degree of latitude takes place in addition to or exclusively by the analysis of the earth's magnetic field.

28. The method according to claim 1, wherein from the amplitude of the pressure fluctuations a degree of waviness is derived.

29. The method according to claim 28, wherein the degree of waviness that was determined is stored.

30. The method according to claim 1, wherein the position of the diver is transmitted to a remote receiver.

31. The method according to claim 1, wherein the receiver is another diver or is on a boat or is on land.

32. The method according to claim 1, wherein the controls of an underwater propulsion device are controlled based on position data.
